(19) United States
(12) Patent Application Publication
(10) Pub. No.: US 2019/0289491 A1
(43) Pub. Date: Sep. 19, 2019

(54) COMMUNICATION DEVICE AND COMMUNICATION METHOD

(71) Applicant: FUJITSU LIMITED, Kawasaki-shi (JP)

(72) Inventors: Satoshi Haraguchi, Fukuoka (JP); Shinya Yamamura, Fukuoka (JP)

(73) Assignee: FUJITSU LIMITED, Kawasaki-shi (JP)

(21) Appl. No.: 16/293,256

(22) Filed: Mar. 5, 2019

(30) Foreign Application Priority Data
Mar. 19, 2018 (JP) 2018-051403

(51) Int. Cl. H04W 28/02; H04L 12/26

(52) U.S. Cl. CPC H04W 28/0236; H04L 69/22; H04L 43/106; H04L 43/0864

(57) ABSTRACT

A communication device includes a memory, and a processor coupled to the memory and the processor configured to perform generation of a first bundle of a first size from transmission target data in accordance with a protocol of a disruption tolerant network, perform transmission of the first bundle to a transmission destination, perform determination of a line state of a connection to the transmission destination by the transmission of the first bundle, perform generation of a second bundle of a second size based on the determined line state from data yet to be transmitted in the transmission target data in accordance with the protocol of the disruption tolerant network, and perform transmission of the second bundle to the transmission destination.

### CROSS-REFERENCE TO RELATED APPLICATION

This application is based upon and claims the benefit of priority of the prior Japanese Patent Application No. 2018-51403, filed on Mar. 19, 2018, the entire contents of which are incorporated herein by reference.

### FIELD

The embodiment discussed herein is related to a communication technology.

### BACKGROUND

Recently, with the spread of wireless access points, terminals such as smart phones or the like may perform communication while switching between a wireless access point and a wide-area wireless coupling of a communication carrier. In such a case, there is a possibility that the communication is affected by the number of terminal coupling and surrounding radio wave conditions, and thus communication quality varies depending on place and time, so that the communication becomes intermittent.

There is a disruption tolerant network (hereinafter described as disruption tolerant networking (DTN)) as a technology that enables data communication under an environment in which communication is intermittent. DTN may be referred to as a delay tolerant network. Standardization of DTN by the internet engineering task force (IETF) is underway, and a protocol applied to DTN is defined in request for comments (RFC) 5050, for example.

Related technologies are disclosed in Japanese Laid-open Patent Publication No. 2014-179749 and Japanese Laid-open Patent Publication No. 11-177621, for example.

### SUMMARY

According to an aspect of the embodiments, a communication device includes a memory, and a processor coupled to the memory and the processor configured to perform generation of a first bundle of a first size from transmission target data in accordance with a protocol of a disruption tolerant network, perform transmission of the first bundle to a transmission destination, perform determination of a line state of a connection to the transmission destination by the transmission of the first bundle, perform generation of a second bundle of a second size based on the determined line state from data yet to be transmitted in the transmission target data in accordance with the protocol of the disruption tolerant network, and perform transmission of the second bundle to the transmission destination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a configuration of a communication system;

FIG. 2 is a diagram illustrating a format of a bundle;

FIG. 3 is a diagram illustrating an example of a hardware configuration of a terminal;

FIG. 4 is a diagram illustrating an example of a functional configuration of a terminal;

FIG. 5 is a diagram illustrating an example of a hardware configuration of a server device;

FIG. 6 is a diagram illustrating an example of a functional configuration of a server device;

FIG. 7 is a flowchart illustrating an example of a communication processing procedure of a terminal;

FIG. 8 is a flowchart illustrating an example of a communication processing procedure of a server device; and

FIG. 9 is a flowchart illustrating an example of a communication processing procedure of a terminal.

### DESCRIPTION OF EMBODIMENT

The related technology may perform processing of transmission to a destination in bundle units obtained by dividing data to be transferred into a given size in communication using DTN. However, this given size is a predetermined fixed value. Therefore, the size is determined before data transmission processing is started, and the size of bundles is not adjusted even when a communication connection is once discoupled and then a connection is newly established, for example. Thus, data transfer performance may be impaired.

An embodiment will hereinafter be described in detail with reference to the drawings. Each piece of processing in the embodiment may be changed as appropriate. Incidentally, in all of the figures of assistance in explaining the embodiment, the same parts are identified by the same reference numerals in principle, and repeated description thereof will be omitted.

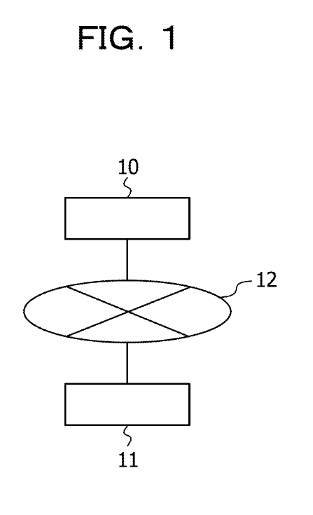

An embodiment will be described in the following. FIG. 1 is a diagram illustrating an example of a configuration of a communication system according to the embodiment. The communication system according to the embodiment includes a terminal 10 and a server device 11. The terminal 10 and the server device 11 are coupled to each other via a network 12.

In the present embodiment, description will be made by taking communication between the terminal 10 and the server device 11 as an example. However, the present embodiment is not limited to this, and is applicable to devices having a communicating function.

The terminal 10 is, for example, a smart phone or a personal computer, and is a communication device having a communicating function. The terminal 10, for example, has a function of performing communication based on the bundle protocol of DTN. The terminal 10 may further have a transmission control protocol/internet protocol (TCP/IP) communicating function provided by a driver of an operating system (OS). In this case, the terminal 10 may perform switching control between communication based on the bundle protocol of DTN and communication based on TCP/IP according to a state of connection to a communication destination. The terminal 10 may, for example, give priority to the communication based on the bundle protocol of DTN when a retention time of the connection to the communication destination is short.

The server device 11 is, for example, a communication device coupled to the Internet and providing a given service by communicating with the terminal 10. The server device 11, for example, has a function of performing communication based on the bundle protocol of DTN. The server device 11 may further have a TCP/IP communicating function provided by a driver of an OS. In this case, the server device 11 may perform switching control between communication based on the bundle protocol of DTN and communication based on TCP/IP according to a state of connection to a communication destination. The server device 11 may, for example, give priority to the communication based on the bundle protocol of DTN when a retention time of the connection to the communication destination is short.

Incidentally, in RFC5050 described above, the bundle protocol of DTN is defined as a protocol of a higher layer than the protocol of the transport layer (for example, corresponding to TCP) and the protocol of the network layer (for example, corresponding to IP). Therefore, the communication based on the bundle protocol of DTN uses TCP/IP as a lower layer, and does not singly function as a communication protocol.

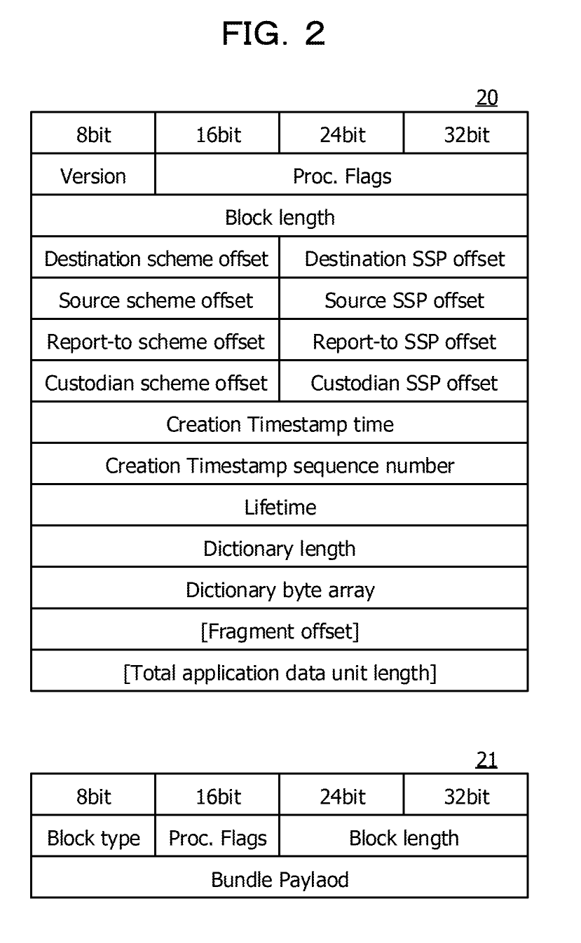

In the communication based on the bundle protocol of DTN, transmission target data may be divided into a given size, a bundle is generated by adding a header to a divided data piece, and transmission is performed in bundle units. FIG. 2 illustrates a format of a bundle. A bundle includes a primary bundle block 20 and a bundle payload block 21. The primary bundle block 20 includes information regarding a transmission source and a destination as well as a life time indicating a time until deletion of the bundle and the like. The bundle payload block 21 includes a payload containing data. Incidentally, each item within the bundle is defined in RFC5050.

In a case where transmission target data is divided into a plurality of bundles, an identical Creation Timestamp and an identical Creation Timestamp sequence number are set to the plurality of bundles on a transmission side. In addition, on the transmission side, the size of the whole of the transmission target data is set as a Total application data unit length, and a Fragment offset indicating a data position (order) is set in each of the plurality of bundles. This enables a reception side receiving the plurality of bundles to assembly the original transmission target data correctly.

Incidentally, the terminal 10 and the server device 11 may be provided with a proxy function to apply the bundle protocol of DTN to the communication of an ordinary client application operating on the terminal 10 and an ordinary server application operating on the server device 11. The proxy function makes it possible to perform processing of protocol conversion of the communication of the client application and the server application from the socket communication of TCP to the communication of the bundle protocol of DTN.

For example, the proxy function changes the destinations of packets transmitted from the client application and the server application to communication destinations, and establishes a local loopback connection within the terminal 10 and the server device 11. Based on the packets received by the loopback, bundles to be transmitted in the communication of the bundle protocol of DTN are generated.

As described above, in the bundle protocol of DTN, processing of transmission to a destination may be performed in bundle units obtained by dividing data to be transferred into a given size. However, this given size is a predetermined fixed value. The size is determined before data transmission processing is started. The size of bundles is not adjusted even when a communication connection is once discoupled and then a connection is newly established, for example. Thus, data transfer performance may be impaired.

DTN is originally a protocol developed assuming an environment in which a large communication delay and communication disruption may occur at all times as in the case of the Interplanetary Internet. In such a severe environment, it is important to transfer data to a transmission destination regardless of the delay. Thus, it suffices to set the size of bundles small in advance, and no problem is presented even when the size of bundles is a fixed value.

On the one hand, application of DTN to a wireless network on the earth (for example, a mountainous area, a remote island, or the like) has recently been studied. In such an environment, relatively urgent data in daily life may conceivably be transmitted, and therefore, unlike the Interplanetary Internet, it is desirable to ensure a certain degree of data communication efficiency.

However, if the size of bundles is set at a relatively small fixed value, there is a possibility of communication efficiency being impaired because data that may be transferred in one time of transmission and reception because of relatively good quality of a radio line is transferred by a large number of times of transmission and reception. On the other hand, if the size of bundles is set at a relatively large fixed value, data is not fragmented, and a failure of transmission and reception is repeated, so that there is a possibility of communication efficiency being impaired. Further, when the size of bundles is a fixed value, it is difficult to follow a change in quality of the radio line.

The above-described problems are newly found as a result of diligent investigation by the inventor. An embodiment that solves the problems will be described in the following.

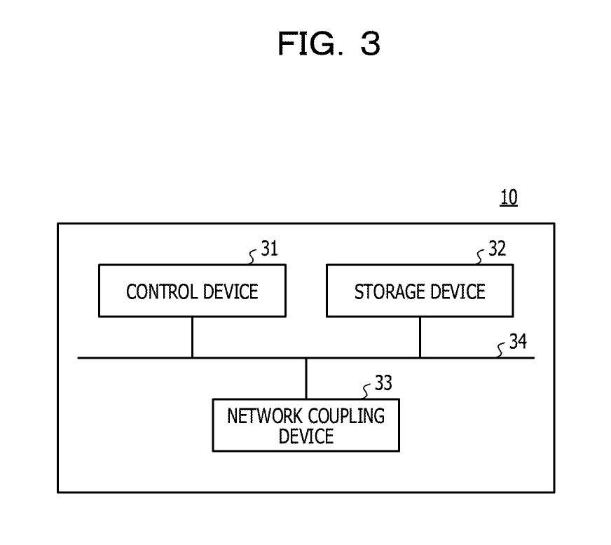

FIG. 3 is a diagram illustrating an example of a hardware configuration of a terminal according to the embodiment. The terminal illustrated in FIG. 3 may be the terminal 10 illustrated in FIG. 1. The terminal 10 includes a control device 31, a storage device 32, and a network coupling device 33, which are coupled to each other via a system bus 34 so as to be capable of signal input and output.

The control device 31 is a device that controls the terminal 10. An electronic circuit such as a central processing unit (CPU), a micro processing unit (MPU), or the like, for example, may be used as the control device 31. The control device 31 performs various kinds of processing such as various kinds of operations, data input and output from and to each hardware constituent unit, and the like, by controlling operation of the terminal 10 based on an OS and various kinds of programs stored in the storage device 32. Various kinds of information needed during the execution of the programs and the like may be obtained from the storage device 32, for example. Incidentally, a part of the processing performed by the control device 31 may be implemented by using dedicated hardware. The control device 31 performs communication processing according to the embodiment based on a communication program including a plurality of instructions according to the embodiment.

The storage device 32, for example, stores the communication program including a plurality of instructions according to the embodiment. The storage device 32 may include a main storage device and an auxiliary storage device. The main storage device, for example, temporarily stores at least a part of the OS and an application program executed by the control device 31. In addition, the main storage device stores various kinds of data needed for the processing of the control device 31. Incidentally, a read only memory (ROM), a random access memory (RAM), a flash memory, or the like, for example, may be used as the main storage device.

The auxiliary storage device may read various kinds of information stored therein or write information based on an instruction from the control device 31. A storage or the like such as a hard disk drive (HDD), a solid state drive (SSD), or the like, may be used as the auxiliary storage device. The auxiliary storage device may store information used in the communication processing according to the embodiment and a result of the processing. In addition, the main storage device and the auxiliary storage device may each have functions of the other.

The network coupling device 33 is, for example, a wireless LAN module. The network coupling device 33 has a function of linking up to an access point on the network.

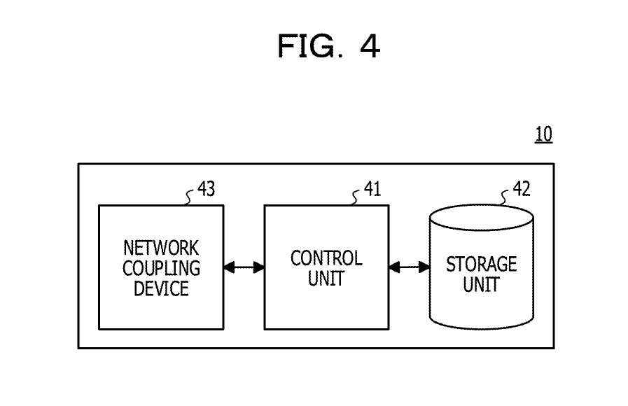

FIG. 4 is a diagram illustrating an example of a functional configuration of a terminal according to the embodiment. The terminal illustrated in FIG. 4 may be the terminal 10 illustrated in FIG. 1. The terminal 10 includes a control unit 41, a storage unit 42, and a network coupling unit 43 as functions. The functions of the control unit 41, the storage unit 42, and the network coupling unit 43 are implemented by the control device 31 by reading a program stored in the storage device 32 and performing various kinds of processing using hardware included in the terminal 10.

A concrete operation of the terminal 10 will be illustrated in the following. The control unit 41 of the terminal 10 transmits, to a communication destination, a bundle generated by dividing transmission target data according to a given fragment size based on the bundle protocol of DTN. When a connection to the communication destination is established, the control unit 41 calculates a line speed based on a round trip time (RTT) from the transmission of data to reception of a positive acknowledgement (ACK) and the size of transmitted data. The control unit 41 determines a fragment size for bundle generation according to the calculated line speed. The control unit 41 generates a new bundle based on a fragment corresponding to the determined fragment size from bundles present in a bundle buffer of the storage unit 42, and transmits the generated new bundle by using the network coupling unit 43.

In a case where the bundle size of the transmitted bundle is 100 KBytes and the RTT from the transmission of the bundle to the reception of the ACK is 20 milliseconds, for example, the control unit 41 of the terminal 10 calculates that the line speed is 40 Mbps (bits per second).

In a case where the line speed is 40 Mbps, for example, the control unit 41 of the terminal 10 may determine that 5 Mbytes, which is an amount of data that may be transmitted in a reference time (period of one second), is the fragment size, and generate a bundle having a bundle size of 5 Mbytes. For example, when a connection to the communication destination is discoupled during transmission of a bundle having a bundle size of 10 Mbytes, and the control unit 41 of the terminal 10 calculates that the line speed of a newly established connection is 40 Mbps, the control unit 41 changes the fragment size to 5 Mbytes, generates a bundle having a bundle size of 5 Mbytes, and transmits the generated bundle.

Incidentally, while the reference time is illustrated as one second, the reference time is not limited to this. For example, the reference time may be set long when overhead due to division is desired to be reduced, or the reference time may be set short when an amount of data to be retransmitted due to the discoupling of the connection is desired to be small.

Further, the reference time may have a range. For example, in a case where the reference time is a period of 0.5 to 1 second and the line speed is 40 Mbps, the fragment size may be determined as 2.5 to 5 Mbytes. In this case, the control unit 41 of the terminal 10 may not change the fragment size when an original fragment size is 3 Mbytes, may change the fragment size to 2.5 Mbytes when the original fragment size is 1 Mbyte, or may change the fragment size to 5 Mbytes when the original fragment size is 10 Mbytes.

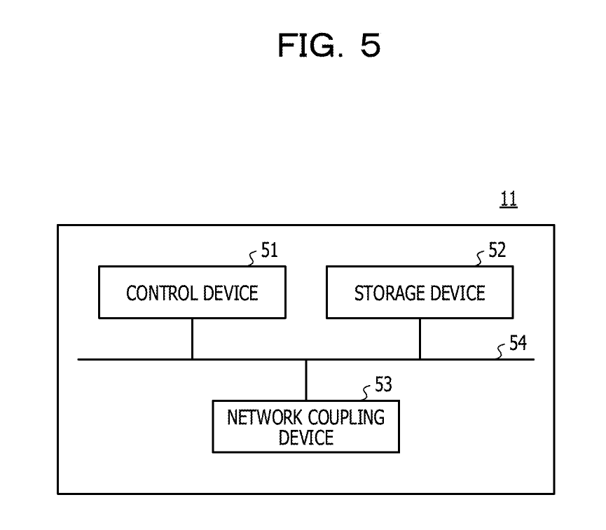

FIG. 5 is a diagram illustrating an example of a hardware configuration of a server device according to the embodiment. The server device illustrated in FIG. 5 may be the server device 11 illustrated in FIG. 1. The server device 11 includes a control device 51, a storage device 52, and a network coupling device 53, which are coupled to each other via a system bus 54 so as to be capable of signal input and output.

The control device 51 is a device that controls the server device 11. An electronic circuit such as a CPU, an MPU, or the like, may be used as the control device 51. The control device 51 performs various kinds of processing such as various kinds of operations, data input and output from and to each hardware constituent unit, and the like, by controlling operation of the server device 11 based on an OS and various kinds of programs stored in the storage device 52. Various kinds of information needed during the execution of the programs and the like may be obtained from the storage device 52, for example. Incidentally, a part of the processing performed by the control device 51 may be implemented by using dedicated hardware. The control device 51 performs communication processing according to the embodiment based on a communication program including a plurality of instructions according to the embodiment.

The storage device 52, for example, stores the communication program including a plurality of instructions according to the embodiment. The storage device 52 may include a main storage device and an auxiliary storage device. The main storage device, for example, temporarily stores at least a part of the OS and an application program executed by the control device 51. In addition, the main storage device stores various kinds of data needed for the processing of the control device 51. Incidentally, a ROM, a RAM, or the like, for example, may be used as the main storage device.

The auxiliary storage device may read various kinds of information stored therein or write information based on an instruction from the control device 51. A storage or the like such as an HDD, an SSD, or the like, may be used as the auxiliary storage device. The auxiliary storage device may store information used in the communication processing according to the embodiment and a result of the processing. In addition, the main storage device and the auxiliary storage device may each have functions of the other.

The network coupling device 53 is, for example, a communication port.

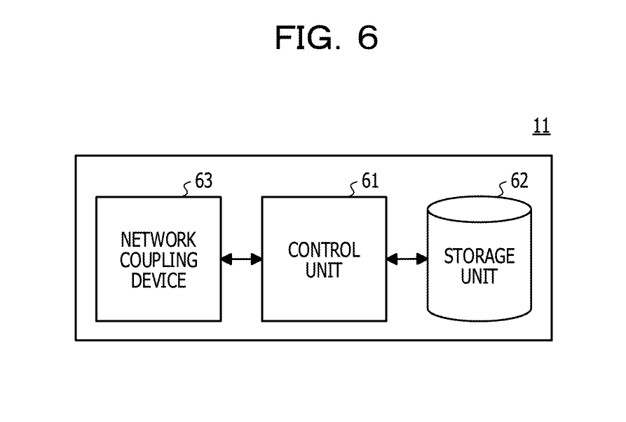

FIG. 6 is a diagram illustrating an example of a functional configuration of a server device according to the embodiment. The server device illustrated in FIG. 6 may be the server device 11 illustrated in FIG. 1. The server device 11 includes a control unit 61, a storage unit 62, and a network coupling unit 63 as functions. The functions of the control unit 61, the storage unit 62, and the network coupling unit 63 are implemented by the control device 51 by reading a program stored in the storage device 52 and performing various kinds of processing using hardware included in the server device 11.

A concrete operation of the server device 11 will be illustrated in the following. The control unit 61 of the server device 11 stores bundles received via the network coupling unit 63 in the bundle buffer of the storage unit 62 based on the bundle protocol of DTN. When receiving all of bundles, the control unit 61 of the server device 11 reconstructs original transmission target data by coupling all of the bundles to each other.

In the foregoing, the terminal 10 illustrates processing at a time of transmission, and the server device 11 illustrates processing at a time of reception. However, without being limited to this, the terminal 10 and the server device 11 may each be able to perform both of processing at a time of transmission and processing at a time of reception similarly.

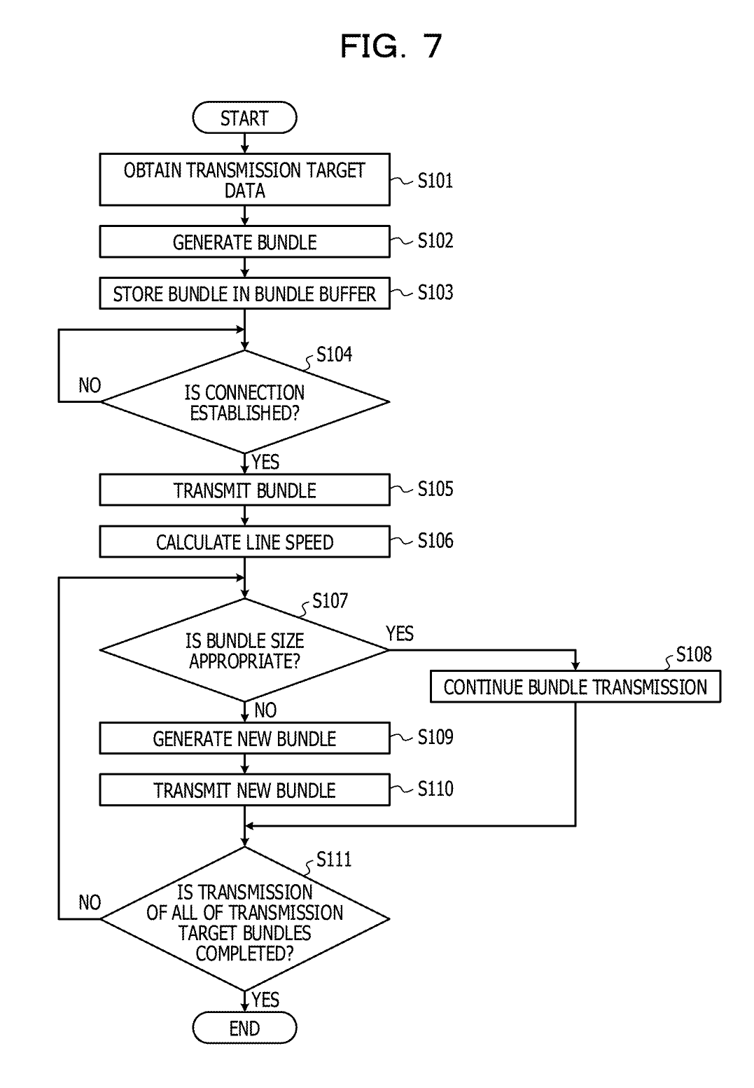

Description will next be made of an example of a communication processing procedure of the terminal 10 according to the embodiment. FIG. 7 is a flowchart illustrating an example of the communication processing procedure of the terminal 10.

For example, the control unit 41 of the terminal 10 obtains transmission target data from a client application operating within the own device (S101). The control unit 41 generates a bundle by dividing the obtained transmission target data in a given fragment size (S102). The control unit 41 stores the generated bundle in the bundle buffer of the storage unit 42 (S103). The control unit 41 determines a state as to whether a connection to a communication destination is established (S104).

When the connection to the communication destination is not established (No in S104), the control unit 41 waits for transmission of the bundle. The control unit 41 may perform the processing of S104 periodically during the wait.

When the connection to the communication destination is established (Yes in S104), the control unit 41 extracts the bundle from the bundle buffer, and transmits the bundle via the network coupling unit 43 (S105).

The control unit 41 calculates the line speed of the connection according to the transmission of the bundle and reception of an ACK (S106). The control unit 41 compares the calculated line speed and the size of the present bundle with each other, and determines whether the size of the bundle is appropriate (S107).

When the size of the bundle is appropriate (Yes in S107), the control unit 41 continues the transmission processing for bundles remaining in the bundle buffer (S108).

When the size of the bundle is not appropriate (No in S107), the control unit 41 generates a new bundle divided according to the fragment size corresponding to the calculated line speed from the bundles remaining in the bundle buffer, and stores the new bundle in the bundle buffer (S109). The control unit 41 transmits the generated new bundle via the network coupling unit 43 (S110). The control unit 41 determines whether transmission of all of transmission target bundles remaining in the bundle buffer is completed (S111). The control unit 41 may proceed to the processing of S111 when a given time passes while performing the processing of S108 or S110.

When the transmission of all of the transmission target bundles is not completed (No in S111), the control unit 41 returns to the processing of S107. When the transmission of all of the transmission target bundle is completed (Yes in S111), the control unit 41 ends the communication processing.

Incidentally, description has been made of a flow in which a return is made to the processing of S107 when No is obtained in S111. However, without being limited to this, the control unit 41 may, for example, return to the respective processing of S108 or S110 when No is obtained in S111. Further, the control unit 41 may return to the processing of S107 periodically while performing the processing of S108 or S110.

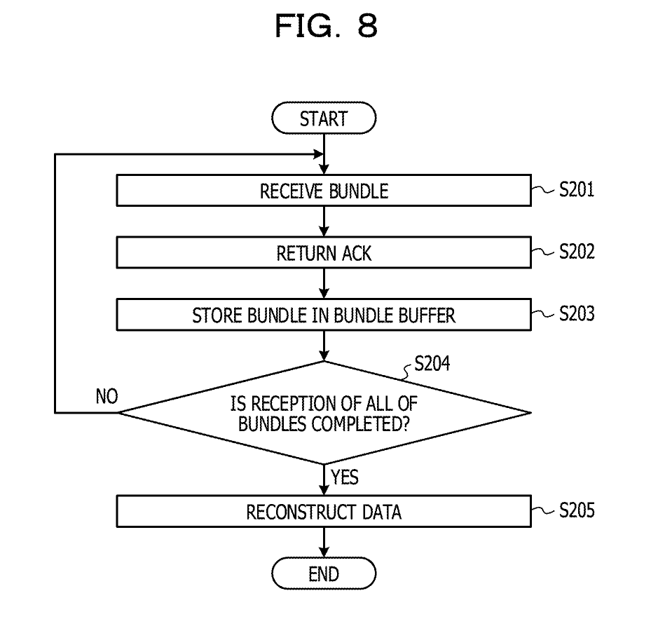

Description will next be made of an example of a communication processing procedure of the server device 11 according to the embodiment. FIG. 8 is a flowchart illustrating an example of the communication processing procedure of the server device 11.

For example, the control unit 61 of the server device 11 receives a bundle via the network coupling unit 63 (S201). The control unit 61 returns an ACK in response to the received bundle (S202). The control unit 61 stores the received bundle in the bundle buffer of the storage unit 62 (S203). The control unit 61 determines whether reception of all of bundles constituting reception target data is completed (S204).

When the reception of all of the bundles is not completed (No in S204), the control unit 61 returns to the processing of S201.

When the reception of all of the bundles is completed (Yes in S204), the control unit 61 reconstructs the reception target data based on the bundles stored in the bundle buffer, and stores the reconstructed data in the storage unit 62 (S205). The control unit 61 ends the communication processing. The reconstructed data may be used by a server application operating within the server device 11.

According to the present embodiment, the terminal 10 adjusts the size of a bundle according to the line speed of connection to a communication destination, and transmits the bundle. An impairment of transfer performance may therefore be suppressed. Hence, the terminal 10 determines whether the size of the bundle is appropriate according to the line speed even in a state in which the bundle may be transmitted in the size of the present bundle, and adjusts the size of the bundle when the size of the bundle is not appropriate.

When the size of the present bundle is large as compared with the communication line, for example, the terminal 10 changes the fragment size, generates a new bundle having a smaller size than the present bundle, and transmits the new bundle. When the size of the present bundle is small as compared with the communication line, for example, the terminal 10 changes the fragment size, generates a new bundle having a larger size than the present bundle, and transmits the new bundle.

In the present embodiment, the terminal 10 determines whether the size of a bundle is appropriate based on one time of calculation of the line speed. However, without being limited to this, the terminal 10 may calculate the line speed a plurality of times at given time intervals, and determine whether the size of the bundle is appropriate based on an average value of a plurality of calculated line speeds.

In addition, in the present embodiment, an example is cited in which bundles generated by dividing the transmission target data based on the given fragment size in advance are stored in the buffer. However, without being limited to this, the terminal 10 may store the transmission target data in the buffer without dividing the transmission target data, cut out data in the fragment size corresponding to the line speed in transmission timing, generate a bundle, and transmit the bundle. In this case, the terminal 10 may, for example, calculate the line speed each time a bundle is transmitted, and adjust the size of a bundle.

In addition, when the terminal 10 receives new transmission target data from the client application after completing the transmission of the transmission target data, the terminal 10 may maintain the fragment size used at the time of transmission of the transmission target data whose transmission is completed as it is, and fragment the new transmission target data. In this case, the terminal 10 may set, to a same size, the size of a last bundle of the transmission target data whose transmission is completed and the size of a first bundle of the new transmission target data.

Further, the terminal 10 may perform the above-described processing of maintaining the fragment size when a time from the completion of transmission of the transmission target data to the reception of the new transmission target data is equal to or less than a threshold value or when the connection to the communication destination is maintained until the terminal 10 receives the new transmission target data.

(Modification)

A modification of the foregoing embodiment will next be described. In the description of the modification, same parts as in the embodiment are identified by the same reference numerals, and description thereof will be omitted. In the modification, cited as an example is a case in which a connection is discoupled while communication based on the bundle protocol of DTN is performed.

When it is difficult for the control unit 41 of the terminal 10 to transmit a bundle extracted from the bundle buffer due to discoupling of a connection to a communication destination, for example, the control unit 41 may return the extracted bundle to the bundle buffer. In this case, the control device 31 may recouple bundles remaining in the bundle buffer including the returned bundle, and redivide the bundles into bundles of the fragment size corresponding to the line speed when the connection to the communication destination is established next.

When the connection to the communication destination is discoupled and a connection is newly established, for example, the control unit 41 of the terminal 10 may adopt a fragment size smaller than the previous fragment size, generate a bundle, and transmit the bundle to the communication destination. When the control unit 41 succeeds in the transmission, the control unit 41 may calculate the line speed, determine the fragment size corresponding to the calculated line speed, and adjust the size of a bundle.

This is intended to avoid a transmission failure due to too large a size of a bundle as compared with the established connection by setting the fragment size small because it is difficult for the terminal 10 to determine the line speed in timing in which a connection is newly established. The terminal 10 may suppress an impairment of transfer efficiency when the terminal 10 adjusts the fragment size in a stage in which the line speed may be calculated.

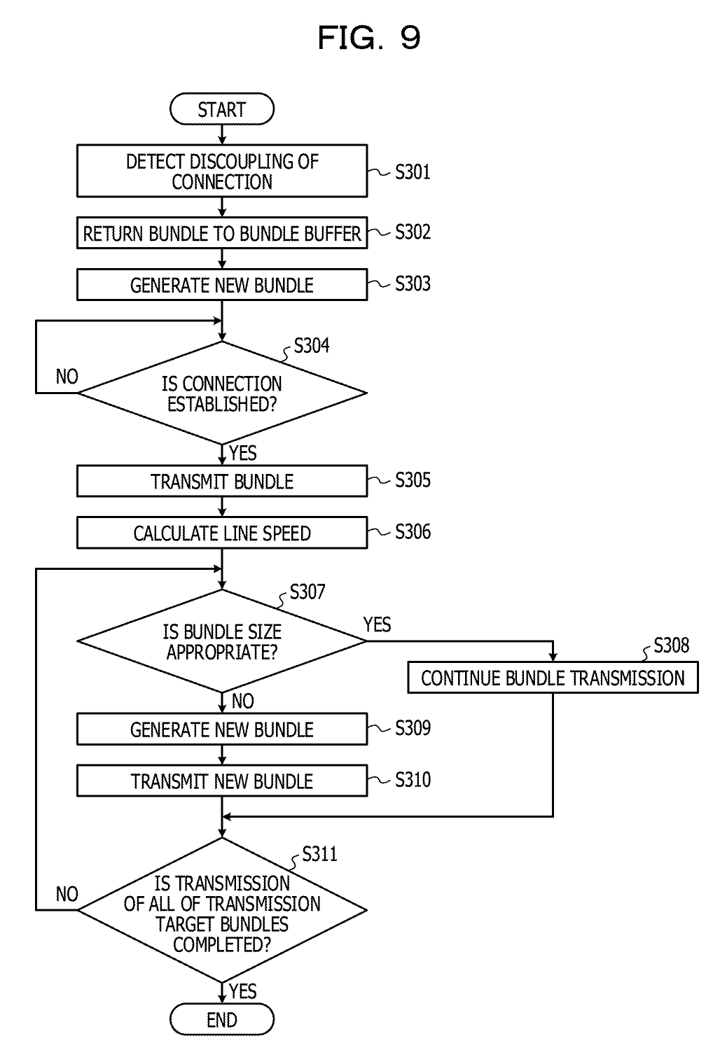

Description will be made of an example of a communication processing procedure of the terminal 10 according to the modification. FIG. 9 is a flowchart illustrating an example of the communication processing procedure of the terminal 10. Incidentally, processing up to S105 is similar to that of the foregoing embodiment, and therefore description thereof will be omitted.

For example, during the transmission of a bundle (S105), the control unit 41 of the terminal 10 detects discoupling of the connection to the communication destination (S301) when performing the transmission after extracting the bundle from the bundle buffer. The control unit 41 returns the untransmitted bundle retained in memory to the bundle buffer (S302). The control unit 41 recouples bundles remaining in the bundle buffer, divides the recoupled data into the fragment size smaller than before the connection is discoupled, generates a new bundle, and stores the new bundle in the bundle buffer (S303). The control unit 41 determines a state as to whether a new connection to the communication destination is established (S304).

When a new connection to the communication destination is not established (No in S304), the control unit 41 waits for transmission of the bundle. The control unit 41 may perform the processing of S304 periodically during the wait.

When a new connection to the communication destination is established (Yes in S304), the control unit 41 extracts the bundle from the bundle buffer, and transmits the bundle via the network coupling unit 43 (S305).

The control unit 41 calculates the line speed of the connection according to the transmission of the bundle (S306). The control unit 41 compares the calculated line speed and the size of the present bundle with each other, and determines whether the size of the bundle is appropriate (S307).

When the size of the bundle is appropriate (Yes in S307), the control unit 41 continues the transmission processing for bundles remaining in the bundle buffer (S308).

When the size of the bundle is not appropriate (No in S307), the control unit 41 generates a new bundle divided according to the fragment size corresponding to the calculated line speed from the bundles remaining in the bundle buffer, and stores the new bundle in the bundle buffer (S309). The control unit 41 transmits the generated new bundle via the network coupling unit 43 (S310). The control unit 41 determines whether transmission of all of transmission target bundles remaining in the bundle buffer is completed (S311). The control unit 41 may proceed to the processing of S311 when a given time passes while performing the processing of S308 or S310.

When the transmission of all of the transmission target bundles is not completed (No in S311), the control unit 41 returns to the processing of S307. When the transmission of all of the transmission target bundles is completed (Yes in S311), the control unit 41 ends the communication processing. The above description has been made assuming that the discoupling of the connection occurs once. However, without being limited to this, the control unit 41 may return to the processing of S301 and perform the communication processing regardless of which step the control unit 41 is performing each time the control unit 41 detects discoupling of a connection.

In the modification, description has been made of a flow in which a return is made to the processing of S307 when No is obtained in S311. However, without being limited to this, the control unit 41 may, for example, return to the respective processing of S308 or S310 when No is obtained in S311. Further, the control unit 41 may return to the processing of S307 periodically while performing the processing of S308 or S310.

As described above, according to the modification, even when discoupling of a connection occurs and a new connection is established, for example, the size of fragments is adjusted according to the line speed of the new connection. An impairment of data transfer performance may therefore be suppressed.

In addition, when the discoupling of the connection occurs, the control unit 41 returns an untransmitted bundle to the bundle buffer. The control unit 41 may therefore adjust the fragment size and generate a new bundle from data including the untransmitted bundle.

When the control unit 41 extracts a bundle to be transmitted from the bundle buffer, for example, the control unit 41 may continue retaining the extracted bundle in the bundle buffer, and delete the bundle from the bundle buffer in timing in which the control unit 41 receives an ACK from the communication destination in response to the transmission of the bundle. In this case, when the discoupling of the connection occurs, the control unit 41 does not need to return the untransmitted bundle to the bundle buffer, but the control unit 41 may recouple bundles remaining in the bundle buffer, adjust the fragment size, and generate a new bundle.

The present technology is not limited to the configurations and procedures of the embodiment and the modification described above, and alteration, recombination, and the like of the processing methods may be performed as appropriate without departing from the spirit of the present technology.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device comprising:
a memory; and
a processor coupled to the memory and the processor configured to
perform generation of a first bundle of a first size from transmission target data in accordance with a protocol of a disruption tolerant network,
perform transmission of the first bundle to a transmission destination,
perform determination of a line state of a connection to the transmission destination by the transmission of the first bundle,
perform generation of a second bundle of a second size based on the determined line state from data yet to be transmitted in the transmission target data in accordance with the protocol of the disruption tolerant network, and
perform transmission of the second bundle to the transmission destination.

2. The communication device according to claim 1, wherein
the generation of the first bundle includes generating a plurality of first bundles each having the first size from the transmission target data,
the generation of the second bundle includes generating a plurality of second bundles each having the second size from the data including first bundles yet to be transmitted among the plurality of first bundles, and
the transmission of the second bundle includes sequentially transmitting a bundle included in the plurality of second bundles to the transmission destination.

3. The communication device according to claim 1, wherein
the line state is a line speed, and
the determination includes calculating the line speed on the basis of the first size and a time from the transmission of the first bundle to reception of a reply from the transmission destination.

4. The communication device according to claim 3, wherein
the determination includes determining whether the first size is appropriate in accordance with the calculated line speed.

5. The communication device according to claim 2, wherein
the processor is configured to
perform generation of a plurality of third bundles each having a third size smaller than the second size from bundles yet to be transmitted among the plurality of second bundles when detecting discoupling of the connection to the transmission destination during the transmission of the second bundle, and
sequentially transmit a bundle included in the plurality of third bundles to the transmission destination in response to establishment of a new connection to the transmission destination.

6. The communication device according to claim 5, wherein
the plurality of second bundles are stored in a buffer, and
the generation of the plurality of third bundles includes returning a specific second bundle to the buffer before generating the plurality of third bundles, the specific second bundle being extracted from the buffer among the plurality of second bundles to be transmitted to the transmission destination, transmission of the specific second bundle not being completed due to the discoupling.

7. The communication device according to claim 5, wherein
the processor is configured to
determine another line state of the new connection by transmission of a third bundle among the plurality of third bundles to the transmission destination, and
generate a plurality of fourth bundles each having a fourth size based on the determined other line state from bundles yet to be transmitted among the plurality of third bundles, and
sequentially transmit a bundle included in the plurality of fourth bundles to the transmission destination.

8. A computer-implemented communication method comprising:
generating a first bundle of a first size from transmission target data in accordance with a protocol of a disruption tolerant network;
transmitting the first bundle to a transmission destination;
determining a line state of a connection to the transmission destination by the transmission of the first bundle;
generating a second bundle of a second size based on the determined line state from data yet to be transmitted in the transmission target data in accordance with the protocol of the disruption tolerant network; and
transmitting the second bundle to the transmission destination.

9. The communication method according to claim 8, wherein
the generating of the first bundle includes generating a plurality of first bundles each having the first size from the transmission target data,
the generating of the second bundle includes generating a plurality of second bundles each having the second size from the data including first bundles yet to be transmitted among the plurality of first bundles, and
the transmitting of the second bundle includes sequentially transmitting a bundle included in the plurality of second bundles to the transmission destination.

10. The communication method according to claim 8, wherein
the line state is a line speed, and
the determining includes calculating the line speed on the basis of the first size and a time from the transmission of the first bundle to reception of a reply from the transmission destination.

11. The communication method according to claim 10, wherein
the determining includes determining whether the first size is appropriate in accordance with the calculated line speed.

12. The communication method according to claim 9, further comprising:
generating a plurality of third bundles each having a third size smaller than the second size from bundles yet to be transmitted among the plurality of second bundles when detecting discoupling of the connection to the transmission destination during the transmission of the second bundle; and
sequentially transmitting a bundle included in the plurality of third bundles to the transmission destination in response to establishment of a new connection to the transmission destination.

13. The communication method according to claim 12, wherein
the plurality of second bundles are stored in a buffer, and
the generating of the plurality of third bundles includes returning a specific second bundle to the buffer before generating the plurality of third bundles, the specific second bundle being extracted from the buffer among the plurality of second bundles to be transmitted to the transmission destination, transmission of the specific second bundle not being completed due to the discoupling.

14. The communication method according to claim 12, further comprising:
determining another line state of the new connection by transmission of a third bundle among the plurality of third bundles to the transmission destination; and
generating a plurality of fourth bundles each having a fourth size based on the determined other line state from bundles yet to be transmitted among the plurality of third bundles; and
sequentially transmitting a bundle included in the plurality of fourth bundles to the transmission destination.

15. A non-transitory computer-readable medium storing instructions executable by one or more computers, the instructions comprising:
one or more instructions for generating a first bundle of a first size from transmission target data in accordance with a protocol of a disruption tolerant network;
one or more instructions for transmitting the first bundle to a transmission destination;
one or more instructions for determining a line state of a connection to the transmission destination by the transmission of the first bundle;
one or more instructions for generating a second bundle of a second size based on the determined line state from data yet to be transmitted in the transmission target data in accordance with the protocol of the disruption tolerant network; and
one or more instructions for transmitting the second bundle to the transmission destination.
